(19) United States
(12) Patent Application Publication
(10) Pub. No.: US 2003/0154421 A1
(43) Pub. Date: Aug. 14, 2003

(54) Information processing device, power source control device, and method, program, and recording medium for controlling information processing device

(75) Inventors: Atsushi Abe, Yokohama-shi (JP); Yuji Chotoku, Tokyo-to (JP); Paul M. Greco, Tucson, AZ (US); Minoru Hara, Sagamihara-shi (JP); Takayuki Katoh, Yokohama-shi (JP); Toshiyuki Shiratori, Tokyo-to (JP)

Correspondence Address: IBM Corporation, Intellectual Property Law Dept. 9CCA/B002, P.O. Box 12195, Res. Tri. Park, NC, 27709, US

(73) Assignee: International Business Machines Corporation, Armonk, NY

(21) Appl. No.: 10/317,323

(22) Filed: Dec. 12, 2002

(30) Foreign Application Priority Data
Dec. 20, 2001 (JP) 2001-388564
Feb. 28, 2002 (JP) 2002-054572

(51) Int. Cl. H02H 3/05

(52) U.S. Cl. 714/2

(57) ABSTRACT

A storage device, as an example of an information processing device, includes an executing unit for executing any one of normal processing, first fault recovery processing and second fault recovery processing, a fault recovery processing unit for allowing the executing unit to initiate the first fault recovery processing with a prerequisite that the executing unit is not operating normally in a first period during the normal processing and for allowing the executing unit to initiate the second fault recovery processing with a prerequisite that the executing unit is not operating normally in a second period during the first fault recovery processing, and a failure information obtaining unit for obtaining an internal state of the executing unit after initiating the first fault recovery processing, the internal state being unobtainable after initiating the second fault recovery, as failure information.

### BACKGROUND OF THE INVENTION

1. Field of the Invention

The present invention relates to an apparatus, method and system for efficiently radiating heat generated in a CPU, or the like, of a computer, and more particularly to a heat sink, a cooling member, a semiconductor-substrate cooling system, a computer, and a radiation method.

2. Description of Related Art

Previously, various modes of interrupting or resetting processors have been disclosed as technologies for attempting to prevent “lock up” caused by failures in various information processing devices, including computers provided with processors (i.e., such as personal computers, workstations and servers, and control circuits provided with controlling processors). For example, Japanese Unexamined Utility Model Publication No. 5(1993)-71924 discloses a reset circuit in which a reset signal of a watchdog timer is used for detecting abnormal operation of a microcomputer by interrupting a program via constant monitoring periods that are inputted to a non-maskable interrupt terminal of the microcomputer. Moreover, Japanese Unexamined Patent Publication No. 11(1999)-249637 discloses an image display device provided with a microcomputer for controlling power source supplying means using non-maskable interrupts occurring in the event that a program “runs away” owing to a watchdog timer.

According to the above-described Japanese Unexamined Utility Model Publication No. 5(1993)-71924 and Japanese Unexamined Patent Publication No. 11(1999)-249637, there is a risk of “lock up” (also used herein as “hang-up” or “freeze”) if processing is not resumed by use of non-maskable interrupt (NMI). In order to enhance reliability of an information processing device further and to facilitate identification of a failure factor, failure management needs to be performed appropriately in accordance with types of failures which occur in various units of the information processing device.

### SUMMARY OF THE INVENTION

Accordingly, it is an object of the present invention to provide an information processing device, a power source control device, and a method, a program and a recording medium for controlling the information processing device, which can solve the above-mentioned problem.

Specifically, a first aspect of the present invention provides an information processing device including an executing unit for executing any one of normal processing, first fault recovery processing and second fault recovery processing, a fault recovery processing unit for allowing the executing unit to initiate the first fault recovery processing with a prerequisite that the executing unit is operating unsuccessfully in a first period during the normal processing and for allowing the executing unit to initiate the second fault recovery processing with a prerequisite that the executing unit is operating unsuccessfully in a second period during the first fault recovery processing, and a failure information obtaining unit for obtaining an internal state of the executing unit after initiating the first fault recovery processing, the internal state being unobtainable after initiating the second fault recovery, as failure information.

Additionally, the information processing device may further include a driving unit for performing mechanical action, and the fault recovery processing unit may stop operation of the driving unit upon instructing the executing unit to initiate the first fault recovery processing.

A second aspect of the present invention provides a power source control device, which is connected to an input/output bus of an information processing device, including a power obtaining unit which obtains main power used for operating the information processing device from the information processing device, and a power source control unit for instructing initiation of supply of the main power through the input/output bus to start up the information processing device with a prerequisite that the supply of the main power has been stopped.

A third aspect of the present invention provides a method of controlling an information processing device for allowing the information processing device to perform processing, including the steps of allowing the information processing device to execute any one of normal processing, first fault recovery processing and second fault recovery processing, allowing the information processing device to initiate the first fault recovery processing with a prerequisite that the normal processing is operating unsuccessfully in a first period, allowing the information processing device to initiate the second fault recovery processing with a prerequisite that the first fault recovery is operating unsuccessfully in a second period, and allowing the information processing device to obtain an internal state of the executing unit after initiating the first fault recovery processing, the internal state being unobtainable after initiating the second fault recovery, as failure information.

In a fourth aspect of the present invention, a program is provided for causing an information processing device to execute procedures for operating as an executing unit for executing any one of normal processing, first fault recovery processing and second fault recovery processing, operating as a fault recovery processing unit for allowing the executing unit to initiate the first fault recovery processing with a prerequisite that the executing unit is operating unsuccessfully in a first period during the normal processing and for allowing the executing unit to initiate the second fault recovery processing with a prerequisite that the executing unit is operating unsuccessfully in a second period during the first fault recovery processing, and operating as a failure information obtaining unit for obtaining an internal state of the executing unit after initiating the first fault recovery processing, the internal state being unobtainable after initiating the second fault recovery, as failure information.

In a fifth aspect of the present invention, a recording medium is provided having a program recorded thereon, the program causing an information processing device to execute procedures for operating as an executing unit for executing any one of normal processing, first fault recovery processing and second fault recovery processing, operating as a fault recovery processing unit for allowing the executing unit to initiate the first fault recovery processing with a prerequisite that the executing unit is operating unsuccessfully in a first period during the normal processing and for allowing the executing unit to initiate the second fault recovery processing with a prerequisite that the executing unit is operating unsuccessfully in a second period during the first fault recovery processing, and operating as a failure information obtaining unit for obtaining an internal state of the executing unit after initiating the first fault recovery processing, the internal state being unobtainable after initiating the second fault recovery, as failure information.

### BRIEF DESCRIPTION OF THE DRAWINGS

Other aspects, features, and advantages of the present invention will become more fully apparent from the following detailed description, the appended claims, and the accompanying drawings in which:

FIG. 1 shows a computer system according to an embodiment of the present invention.

FIG. 2 shows a storage device 110 according to an embodiment of the present invention.

FIG. 3 shows a flow of processing of the storage device according to an embodiment of the present invention.

FIG. 4 shows an example of a hardware configuration for a computer according to an embodiment of the present invention.

FIG. 5 shows a storage device according to a first modified example of an embodiment of the present invention.

FIG. 6 shows a power source control part of a power source control device according to a second modified example of an embodiment of the present invention.

### DETAILED DESCRIPTION

The use of figure reference labels in the claims is intended to identify one or more possible embodiments of the claimed subject matter in order to facilitate the interpretation of the claims. Such labeling is not to be construed as necessarily limiting the scope of those claims to the embodiments shown in the corresponding figures. The preferred embodiments of the present invention and its advantages are best understood by referring to the drawings, like numerals being used for like and corresponding parts of the various drawings. Though the present invention will be described with reference to one or more certain preferred embodiments, it should be understood that the use of embodiments is not intended to limit the scope of the present invention as defined in the appended claims, and that combinations of characteristics, features and the like as may be described in the embodiment are not always necessarily required in their entirety in order to be qualified as a solution according to the present invention.

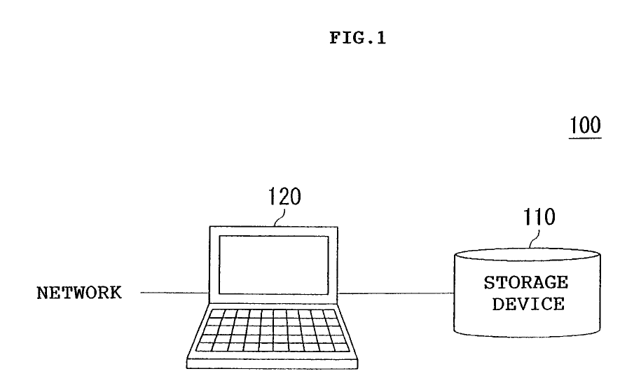

FIG. 1 shows a computer system 100 according to the embodiment. The computer system 100 according to the embodiment includes a storage device 110 and a computer 120. Here, the storage device 110 is one example of an information processing device according to the present invention.

The storage device 110 stores and retrieved data such as files in response to requests from the computer 120, another computer connected to the computer 120 via a network, or the like. The storage device 110 according to the embodiment includes a drive portion such as a hard disk drive, a tape drive, an optical disk drive or a magneto-optical disk drive for performing mechanical action. The storage device 110 has a built-in controlling processor and performs various processing required to the storage device 110 by use of the controlling processor.

The computer 120 is connected to the storage device 110, whereby the computer 120 requests reading or writing the data with respect to the storage device 110. The computer 120 is connected to the storage device 110 by use of an interface for a storage device such as a SCSI interface, an IDE interface or a fiber channel interface. Alternatively, the computer 120 may be connected to the storage device 110 by use of an interface for a generic device such as WAN or LAN.

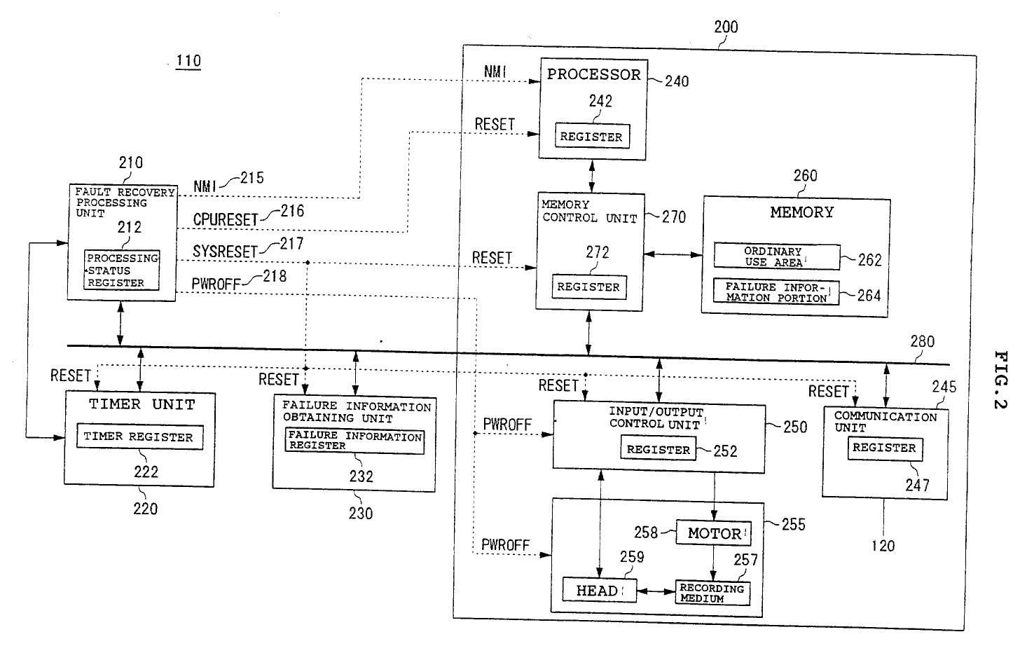

FIG. 2 shows a storage device 110 according to the embodiment. The storage device 110 according to the embodiment includes an executing unit 200, a fault recovery processing unit 210, a timer unit 220 and a failure information obtaining unit 230.

The executing unit 200 controls various units inside the storage device 110 and executes any one of normal processing, first fault recovery processing, second fault recovery processing or third fault recovery processing. The executing unit 200 includes a processor 240, a communication unit 245, an input/output control unit 250, a driving unit 255, a memory 260 and a memory control unit 270.

In the normal processing, the executing unit 200 performs transmission and reception of commands or data between the storage device 110 and the computer 120, and processes such as storage and/or retrieval of the data such as files based on requests from the computer 120. In any event of the first fault recovery processing, the second fault recovery processing and the third fault recovery processing, the executing unit 200 obtains failure information, which is information to be used for executing analyses, identification and/or restoration of failure. In any event of the normal processing, the first fault recovery processing, the second fault recovery processing and the third fault recovery processing, the executing unit 200 transmits normal-operation information to the timer unit 220 indicating that the executing unit 200 is in normal operation, at intervals shorter than a preset period, for example.

The fault recovery processing unit 210 detects that the executing unit 200 is not operating normally for a preset period, and allows the executing unit 200 to initiate fault recovery processing. More specifically, if the executing unit 200 is not operating normally for a first period during the normal processing, the fault recovery processing unit 210 allows the executing unit 200 to initiate the first fault recovery processing. Moreover, if the executing unit 200 is not operating normally for a second period during the first fault recovery processing, the fault recovery processing unit 210 allows the executing unit 200 to initiate the second fault recovery processing. Moreover, if the executing unit 200 is not operating normally for a third period during the second fault recovery processing, the fault recovery processing unit 210 allows the executing unit 200 to initiate the third fault recovery processing. Furthermore, if the executing unit 200 is not operating normally for a fourth period during the third fault recovery processing, the fault recovery processing unit 210 allows the executing unit 200 to resume the third fault recovery processing.

The fault recovery processing unit 210 includes a processing-status register 212 for storing information indicating as to which processing out of the normal processing, the first fault recovery processing, the second fault recovery processing and the third fault recovery processing the storage device 110 is executing at the moment. The fault recovery processing unit 210 according to the present invention stores information “0” when the storage device 110 is operating the normal processing, information “1” when the storage device 110 is operating the first fault recovery processing, information “2” when the storage device 110 is operating the second fault recovery processing, and information “3” when the storage device 110 is operating the third fault recovery processing, into the processing-status register 212.

Additionally, the fault recovery processing unit 210 may further include processing such as instructing the executing unit 200 to resume the first fault recovery processing for a specified number of times when the executing unit 200 is not operating normally for the second period during the first fault recovery processing. In this case, the fault recovery processing unit 210 may allow the executing unit 200 to initiate the second fault recovery processing when the fault recovery processing unit 210 detects that the executing unit 200 is not yet operating normally after instructing resumption of the first fault recovery processing for the specified number of times.

The fault recovery processing unit 210 outputs an NMI signal 215, a CPURESET signal 216, a SYSRESET signal 217 and PWROFF signal 218, as signals for instructing the executing unit 200, the timer unit 220 and the failure information obtaining unit 230 to initiate fault recovery processing.

The NMI signal 215 refers to a signal line used for executing non-maskable interrupt with respect to the processor 240. The fault recovery processing unit 210 executes the non-maskable interrupt with respect to the processor 240 by use of the NMI signal 215 upon initiation of the first fault recovery processing, whereby the fault recovery processing unit 210 allows the processor 240 to initiate the first fault recovery processing.

The CPURESET signal 216 refers to a signal line used for resetting the processor 240. The fault recovery processing unit 210 resets the processor 240 by use of the CPURESET signal 216 upon initiation of the second fault recovery processing, whereby the fault recovery processing unit 210 allows the processor 240 to initiate the second fault recovery processing.

The SYSRESET signal 217 refers to a signal line used for resetting the entire storage device 110 including the timer unit 220, the failure information obtaining unit 230, the communication unit 245, the input/output control unit 250, the driving unit 255, and the memory control unit 270. The fault recovery processing unit 210 resets the entire storage device 110 by use of the SYSRESET signal 217 upon initiation of the third fault recovery processing, whereby the fault recovery processing unit 210 allows the storage unit 110 to initiate the third fault recovery processing. In this event, the fault recovery processing unit 210 resets the processor 240 by use of the CPURESET signal 216 upon resetting the entire storage device 110 at initiation of the third fault recovery processing, whereby the fault recovery processing unit 210 allows the processor 240 to initiate the third fault recovery processing.

The PWROFF signal 218 refers to a signal line used for stopping action of the driving unit 255. The fault recovery processing unit 210 stops action of the driving unit 255 by use of the PWROFF signal 218 upon initiation of the first fault recovery processing.

Instead, the fault recovery processing unit 210 may apply other modes of instructions which are different from the above-described modes of instructions according to the embodiment, such as maskable interrupt, or resetting only one of the processor 240 and the memory control unit 270. Moreover, the fault recovery processing unit 210 may apply other combinations of instructions for initiating each fault recovery processing which are different from the above-described combinations, such as resetting the processor 240 upon the first fault recovery processing and resetting the entire storage device 110 upon the second fault recovery processing.

The timer unit 220 is a watchdog timer, which detects that the executing unit 200 is not operating normally for a set period and notifies the fault recovery processing unit 220 of such an event. The timer unit 220 includes a timer register 222 for use in measurement for the set period.

The timer unit 220 conducts measurement for the set period in accordance with the following method. First, the timer unit 220 obtains a timer value for measuring a preset period from the fault recovery processing unit 210 and stores the timer value in the timer register 222. Next, the timer unit 220 decrements the timer value stored in the timer register 222 at every cycle of a timer clock. Next, upon receipt of normal-operation information from the executing unit 200 indicating that the executing unit 200 is operating normally, the timer unit 220 stores the timer value for measuring the preset period in the timer register 222 again, and initiates the measurement for the set period again. Meanwhile, when the timer value reaches 0 (a timeout), the timer unit 220 detects that the executing unit 200 is not operating normally for the period set in the timer register 222.

Here, the executing unit 200 is programmed to transmit the normal-operation information, which indicates that the executing unit 200 is operating normally, to the timer unit 220 at intervals shorter than the preset period. Accordingly, if the timer unit 220 does not receive the normal-operation information from the executing unit 200 for the preset period, the timer unit 220 judges that there is an anomaly in the program operation by the executing unit 200, and the anomaly can be thereby detected.

The executing unit 200 may also transmit information as the normal-operation information indicating an instruction to the timer unit 220 to initiate measurement for the set period. In this case, the timer unit 220 includes a timer set value register for storing a timer value corresponding to the set period and a timer value register for storing a timer value at a current moment collectively as the timer register 222. Moreover, upon receipt of the normal-operation information from the executing unit 200, the timer unit 220 copies the value stored in the timer set value register into the timer value register, and then initiates measurement for the period set in the timer set value register again.

The executing unit 200 may also transmit information for setting a period for measurement to the timer register 222 inside the timer unit 220. In this case, the timer unit 220 includes a timer value register for storing a timer value at a current moment as the timer register 222. The timer unit 220 receives the timer value to be set on the timer value register inside the timer unit 220 as the normal-operation information and stores the normal-operation information in the timer value register inside the timer unit 220, whereby the timer unit 220 initiates measurement for the set period again by use of the timer value.

Using the timer unit 220, the fault recovery processing unit 210 detects that the executing unit 200 is not operating normally for the first period during the normal processing, that the executing unit 200 is not operating normally for the second period during the first fault recovery processing, that the executing unit 200 is not operating normally for the third period during the second fault recovery processing, and that the executing unit 200 is not operating normally for the fourth period during the third fault recovery processing. Here, the fault recovery processing unit 210 may set the first period, the second period, the third period and the fourth period to be set on the timer unit 220 as mutually equal lengths of periods, or alternatively, as mutually different lengths of periods relevant to contents of the normal processing, the first fault recovery processing, the second fault recovery processing and the third fault recovery processing.

The failure information obtaining unit 230 obtains failure information from the executing unit 200 concerning failure occurred inside the storage device 110, and stores the failure information in a failure information register 232, which is a storage area where recorded contents will not be lost even if the entire storage device 110 is reset. Then, upon receipt of an instruction from the computer 120, the failure information obtaining means 230 transfers the failure information stored in the failure information register 232 to the computer 120 via the communication unit 245. A user of the computer 120 or an administrator of the storage device 110 performs an analysis, identification and restoration of the failure in the storage device 110 based on the failure information transferred from the storage device 110.

The executing unit 200 includes the processor 240, the communication unit 245, the input/output control unit 250, the driving unit 255, the memory 260 and the memory control unit 270.

The processor 240 is a functional unit which executes commands for controlling the storage device 110. The processor 240 includes a register 242 to be used when the processor 240 executes the commands. Instead of the embodiment as described above, the executing unit 200 may include a plurality of processors 240.

The communication unit 245 is a functional unit which executes transmission and reception of commands or data with the computer 120. The communication unit 245 includes a register 247 for holding information such as setting information concerning communication with the computer 120 and information indicating a communication status.

The input/output control unit 250 is a functional unit which controls the driving unit 255 to retrieve or write the data in response to request commands received from the computer 120 via the communication unit 245. The input/output control unit 250 includes a register 252 for holding information such as setting information of data storage formats in the driving unit 255 and access status of the driving unit 255.

The driving unit 255 is a functional unit which performs data retrieval or data writing by mechanical action based on instructions from the input/output control unit 250. The driving unit 255 includes a recording medium 257 for storing the data received from outside via the communication unit 245 and the input/output control unit 250, a motor 258 and a head 259 for use in access to the recording medium 257. In the event of having access to the data inside the recording medium 257, the input/output control unit 250 according to the embodiment first controls the motor 258 such that the head 259 is positioned on a portion on the recording medium 257 where target data are recorded. Next, the input/output control unit 250 controls the motor 258 to have access to the target data by use of the head 259. Meanwhile, upon receipt of a signal from the PWROFF signal 218 when the fault recovery processing unit 210 instructs initiation of the first fault processing, the driving unit 255 stops action of the motor 258 and access to the recording medium 257 with the head 259.

The memory 260 is a memory such as a ROM and/or a RAM for storing programs for the processor 240 used to control the storage device 110, the data, and the like. The memory 260 includes an ordinary use area 262 which stores the programs concerning control of the storage device 110 and the data, and a failure information recording portion 264 for storing the failure information concerning the failure occurred inside the storage device 110.

The memory control unit 270 connects among the fault recovery processing unit 210, the timer unit 220, the failure information obtaining unit 230, the processor 240, the communication unit 245, the input/output control unit 250 and the memory 260, and relays data transfer therebetween, and so forth. The memory control unit 270 includes a register 272 which holds information such as setting information concerning data transfer among the fault recovery processing unit 210, the timer unit 220, the failure information obtaining unit 230, the processor 240, the communication unit 245, the input/output control unit 250 and the memory 260.

An I/O bus 280 connects among the fault recovery processing unit 210, the timer unit 220, the failure information obtaining unit 230, the communication unit 245, the input/output control unit 250 and the memory control unit 270. The I/O bus 280 may be an input/output bus such as, for example, a PCI bus standardized by PCI Special Interest Group (PCI-SIG), which connects each of the processor 240, the memory 260, the memory control unit 270 and the like, and peripheral devices such as the communication unit 245, the input/output control unit 250 and the like.

The executing unit 200 according to the embodiment performs processing by use of internal states held in the register 242, the register 247, the register 252, the ordinary use area 262, the register 272 and the like. The register 242 refers to one example of a first recording portion according to the present invention. Moreover, the register 247, the register 252 and the register 272 collectively refer to one example of a second recording unit according to the present invention.

When the fault recovery processing unit 210 resets the processor 240 to initiate the second fault recovery processing, the register 242 is initialized. Therefore, after initiating the second fault recovery processing, the failure information obtaining means 230 cannot obtain an internal state of the register 242 after the normal processing or immediately after initiating the first fault recovery processing. Moreover, when the fault recovery processing unit 210 resets the entire storage device 110 to initiate the third fault recovery processing, the register 242, the register 247, the register 252 and the register 272 are initialized.

Therefore, after initiating the third fault recovery processing, the failure information obtaining means 230 cannot obtain internal states of the register 242, the register 247, the register 252 and the register 272 immediately after initiating the second fault recovery processing. Meanwhile, the ordinary use area 262 and the failure information recording portion 264 are not initialized even if the fault recovery processing unit 210 initiates the second fault recovery processing or the third fault recovery processing.

After initiating the first fault recovery processing, the failure information obtaining unit 230 obtains an internal state held by the processor 240 out of the register 242, which is the internal state unobtainable after initiating the second fault recovery, as the failure information. Here, in the first fault recovery processing, the processor 240 may obtain part or all of the internal state held by the register 242 and store the internal state in the failure information recording portion 264. In this case, the failure information obtaining unit 230 obtains the internal state of the processor 240 stored in the failure information recording portion 264 as the failure information, and stores the failure information in the failure information register 232. Alternatively, after initiating the first fault recovery processing, the processor 240 may store information held by a portion other than the register 242 inside the processor 240, which is the information to be initialized upon initiating the second fault recovery processing, into the failure information recording portion 264.

Similarly, after initiating the second fault recovery processing, the failure information obtaining unit 230 obtains internal states held inside the executing unit 200 out of the register 242, the register 247, the register 252 and the register 272, which are the internal states unobtainable after initiating the third fault recovery processing, as the failure information. Here in the second fault recovery processing, the processor 240 may have access to the register 242, the register 247, the register 252 and the register 272, obtain part or all of the internal states held therein as the failure information and store the failure information in the failure information recording portion 264. In this case, the failure information obtaining unit 230 obtains the internal states of the processor 240 stored in the failure information recording portion 264 as the failure information, and stores the failure information in the failure information register 232. Alternatively, after initiating the second fault recovery processing, the processor 240 may store information held by a portion other than the register 242 inside the processor 240, a portion other than the register 247 inside the communication unit 245, a portion other than the register 252 inside the input/output control unit 250 or a portion other than the register 272 inside the memory control unit 270, which is the information to be initialized upon initiating the third fault recovery processing, into the failure information recording portion 264.

Furthermore, after initiating the third fault recovery processing, the failure information obtaining unit 230 may further obtain information stored in the ordinary use area 262 as the failure information, in addition to the internal states of the respective units of the storage device 110 which are stored in the failure information register 232.

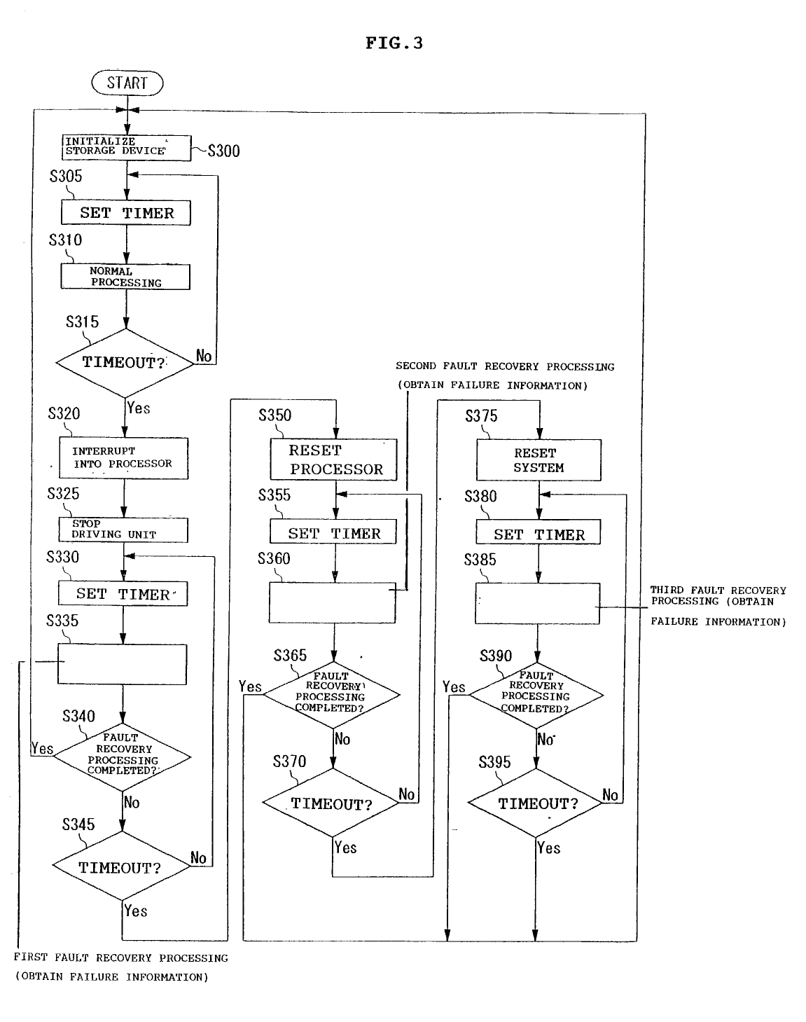

FIG. 3 depicts a flow of processing with the storage device 110 according to the embodiment.

First, the storage device 110 is initialized when a power source is turned on (S300). Upon initializing the storage device 110, the fault recovery processing unit 210 set the processing-status register 212 to “0” to indicate that the storage device 110 is in normal operation. Next, the fault recovery processing unit 210 sets up the timer register 222 inside the timer unit 220 and initiates measurement for the first period (S305). Then, the storage device 110 performs the normal processing (S310). Here, the processor 240 transmits the normal-operation information to the timer unit 220 via the memory control unit 270 and the I/O bus 280 at intervals shorter than the first period during the normal processing, and proceeds with S305 to initiate measurement for the first period again (S315).

Upon detecting that the processor 240 is not operating normally for the first period, the timer unit 220 notifies the fault recovery processing unit 210 of the timeout (S315). Upon receipt of a timeout notice, the fault recovery processing unit 210 performs non-maskable interrupt into the processor 240 by use of the NMI signal 215 (S320). Next, the fault recovery processing unit 210 uses the PWROFF signal 218 to allow the driving unit 255 to stop action of the motor 258 and access to the recording medium 257 with the head 259 (S325). Next, the fault recovery processing unit 210 sets the processing-status register 212 to “1” to indicate that the storage device 110 is in process of the first fault recovery processing and sets up the timer register 222 inside the timer unit 220 to initiate measurement for the second period (S330).

Then, the storage device 110 performs the first fault recovery processing (S335). Specifically, the processor 240 obtains the internal state held in the register 242 or the like and stores the internal state in the failure information recording portion 264. Then, the failure information obtaining unit 230 obtains the internal state of the register 242 or the like stored in the failure information recording portion 264 as the failure information and stores the failure information in the failure information register 232. When the first fault recovery processing is completed, the processor 240 proceeds with S300 (S340), and allows the fault recovery processing unit 210 to instruct resetting of the entire storage device 110 (S300). Moreover, the processor 240 transmits the normal-operation information to the timer unit 220 at intervals shorter than the second period during the first fault recovery processing, and proceeds with S330 to initiate measurement for the second period again (S345).

Upon detecting that the processor 240 is not operating normally for the second period, the timer unit 220 notifies the fault recovery processing unit 210 of the timeout (S345). Upon receipt of a timeout notice, the fault recovery processing unit 210 resets the processor 240 by use of the CPURESET signal 216 (S350). Next, the fault recovery processing unit 210 sets the processing-status register 212 to “2” to indicate that the storage device 110 is in process of the second fault recovery processing and sets up the timer register 222 inside the timer unit 220 to initiate measurement for the third period (S355).

Then, the storage device 110 performs the second fault recovery processing (S360). Specifically, the processor 240 obtains the internal states held in the register 242, the register 247, the register 252, the register 272, or the like and stores the internal states in the failure information recording portion 264. Then, the failure information obtaining unit 230 obtains the internal states of the register 242, the register 247, the register 252, the register 272, or the like stored in the failure information recording portion 264 as the failure information and stores the failure information in the failure information register 232. When the second fault recovery processing is completed, the processor 240 proceeds with S300 (S365), and allows the fault recovery processing unit 210 to instruct resetting of the entire storage device 110 (S300). Moreover, the processor 240 transmits the normal-operation information to the timer unit 220 at intervals shorter than the third period during the second fault recovery processing, and proceeds with S355 to initiate measurement for the third period again (S370).

Upon detecting that the processor 240 is not operating normally for the third period, the timer unit 220 notifies the fault recovery processing unit 210 of the timeout (S370). Upon receipt of a timeout notice, the fault recovery processing unit 210 resets the entire storage device 110 by use of the CPURESET signal 216 and the SYSRESET signal 217 (S375). Next, the fault recovery processing unit 210 sets the processing-status register 212 to “3” to indicate that the storage device 110 is in process of the third fault recovery processing and sets up the timer register 222 inside the timer unit 220 to initiate measurement for the fourth period (S380).

Then, the storage device 110 performs the third fault recovery processing (S385). Specifically, the failure information obtaining unit 230 obtains the internal states of the storage device 110 stored in the ordinary use area 262 and the failure information recording portion 264 and stores the internal states in the failure information register 232 as the failure information. When the third fault recovery processing is completed, the processor 240 proceeds with S300 (S390), and allows the fault recovery processing unit 210 to instruct resetting of the entire storage device 110 (S300). Moreover, the processor 240 transmits the normal-operation information to the timer unit 220 at intervals shorter than the fourth period during the third fault recovery processing, and proceeds with S380 to initiate measurement for the third period again (S395).

Upon detecting that the processor 240 is not operating normally for the fourth period, the timer unit 220 notifies the fault recovery processing unit 210 of the timeout (S395). Upon receipt of a timeout notice, the fault recovery processing unit 210 proceeds with S300 to initialize the storage device 110.

Instead of the processing as described above, the executing unit 200 may perform processing for restoring the respective units inside the storage device 110 in the course of the fault recovery processing in S335, S360 and/or S385. In this case, the executing unit 200 may proceed with the S300 if fault restoration is carried out properly.

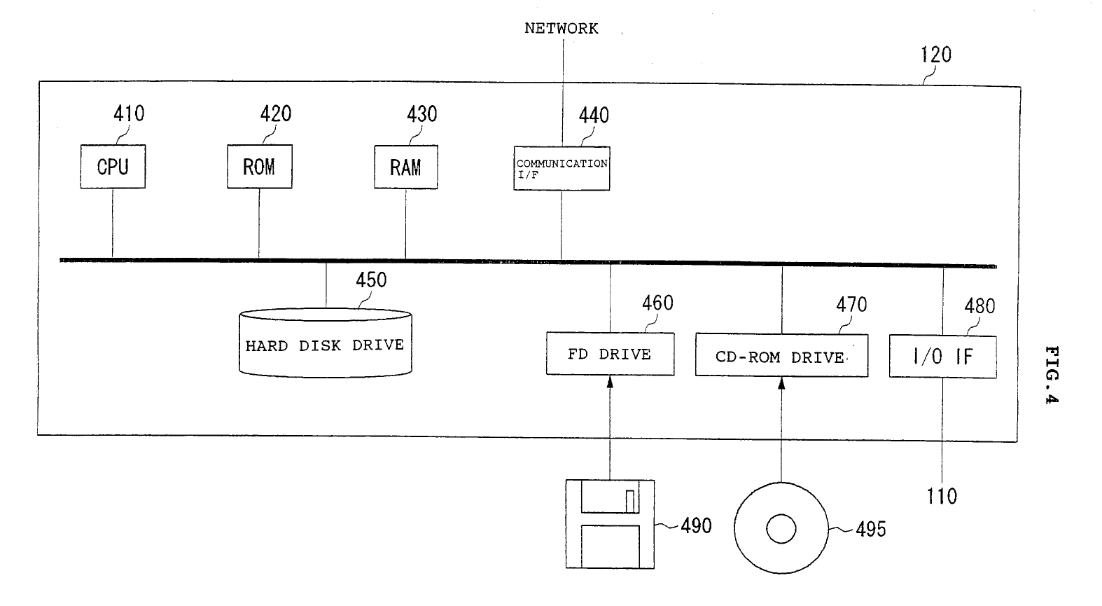

FIG. 4 shows one example of a hardware configuration of the computer 120 according to an embodiment of the present invention.

The computer 120 according to the embodiment includes a CPU 410, a ROM 420, a RAM 430, a communication interface 440, a hard disk drive 450, a floppy disk drive 460, a CD-ROM drive 470 and an I/O interface 480. The CPU 410 operates based on programs stored in the ROM 420 and the RAM 430 to control the respective sections. The communication interface 440 effectuates communication with other devices via a network. The hard disk drive 450 stores programs and data to be used by the computer 120. The floppy disk drive 460 retrieves programs or data from a floppy disk 490 and provides the programs or the data to the I/O interface 480. The CD-ROM drive 470 retrieves programs or data from a CD-ROM 495 and provides the programs or the data to the I/O interface 480. The I/O interface 480 transmits the programs or the data provided by the floppy disk drive 460 or the CD-ROM drive 470 to the storage device 110.

Programs to be provided to the storage device 110 are presented by a user with a recording medium such as the floppy disk 490 or the CD-ROM 495 that stores the programs. The programs are retrieved out of the recording medium, installed in the storage device 110 via the I/O interface 480, and then executed by the storage device 110. Instead, the storage device 110 may further include a floppy drive 460 or a CD-ROM drive 470 or the like, so that the storage device 110 can retrieve and execute the programs directly out of the recording medium.

The programs stored in the recording medium to be provided to the storage device 110 include an execution module, a fault recovery processing module, a timer module and a failure information obtainment module. These modules refer to programs for causing the storage device 110 to operate as the executing unit 200, the fault recovery processing unit 210, the timer unit 220, and the failure information obtaining unit 230, respectively.

The above-described programs or modules may be stored in other external recording media. In addition to the floppy disk 490 and the CD-ROM 495, an optical recording medium such as a DVD or a PD, a magneto-optical recording medium such as an MD, a tape medium, and a semiconductor memory such as an IC card may be used as the recording media. Moreover, it is also possible to use storage devices such as a hard disk or a RAM provided on a server system connected to either an exclusive network or the Internet, so that the programs are provided to the storage device 110 via the network.

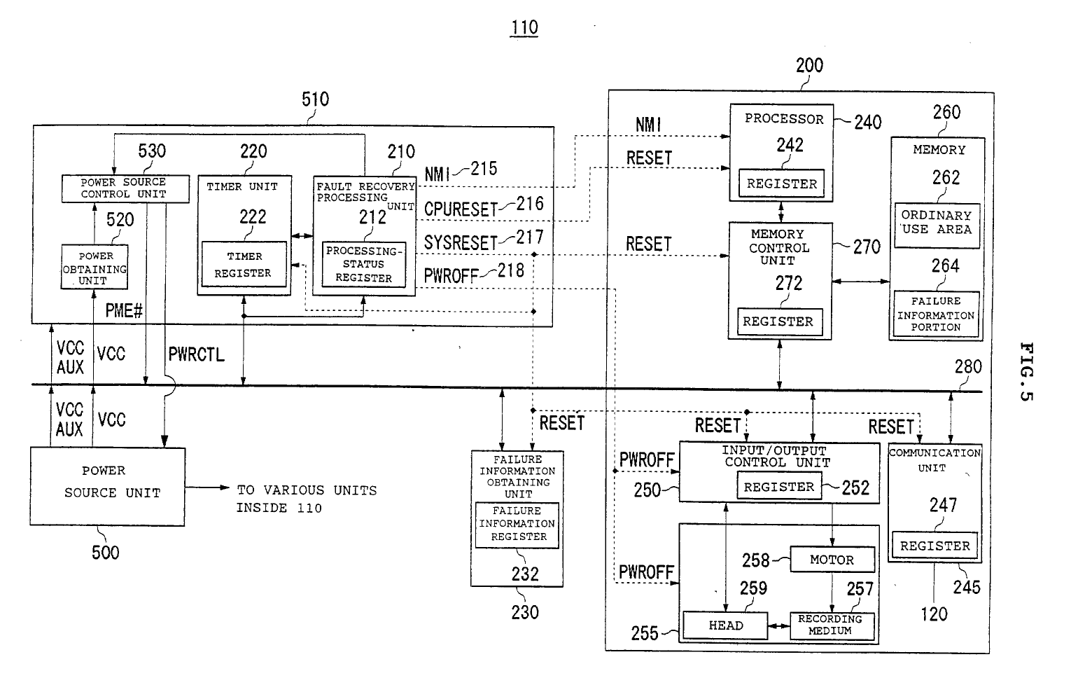

FIG. 5 shows a storage device 110 according to a first modified example of the embodiment. Since an executing unit 200 and a failure information obtaining unit 230 in FIG. 5 are similar to the corresponding members in FIG. 2, description thereof will be omitted.

The modified example will be described on the premise that an I/O bus 280 is a PCI bus including a Power Management Event (PME#) signal for controlling a power source. The PME# signal is defined by “PCI Bus Power Management Interface 1.1,” which is a specification by PCI-SIG, and the like. In place of this, the I/O bus 280 may be a different input/output bus provided with an interface for controlling the power source.

A power source unit 500 supplies various units inside the storage device 110 with main power which is used in the operation of the storage device 110. Here, the power source unit 500 supplies the main power to a failure information obtaining unit 230, a communication unit 245 and a power source control device 510, which are connected to the I/O bus 280, through a power supply pin Vcc of the I/O bus 280.

Additionally, the power source unit 500 receives instructions to turn on the power of the storage device 110 through the PME# signal on the I/O bus 280. If the PME# signal has a logical value 1, the power source unit 500 initiates supply of the main power to turn on the power of the storage device 110. Meanwhile, the power source unit 500 receives instructions to turn off the power of the storage device 110 through a PWRCTL signal from the power source control device 510. If the PWRCTL signal has a logical value 1, the power source unit 500 stops the supply of the main power to turn off the power of the storage device 110.

Further, in both the cases where the main power of the power source unit 500 is supplied and where it is stopped, the power source unit 500 supplies auxiliary power to the I/O bus 280 through a power supply pin VccAUX. In other words, the power source unit 500 always supplies the auxiliary power to the I/O bus 280 as long as power is supplied to the power source unit 500 from an external power source.

The power source control device 510 is an I/O card connected to the I/O bus 280 of a storage device 110 main body which includes the executing unit 200, the failure information obtaining unit 230 and the power source unit 500, and the power source control device 510 controls the power source unit 500. In both the cases where the main power is supplied and where the supply of the main power is stopped, the power source control device 510 can operate using the auxiliary power VccAUX which is supplied through the I/O bus 280. The power source control device 510 has a fault recovery processing unit 210, a timer unit 220, a power obtaining unit 520 and a power source control unit 530. Since the fault recovery processing unit 210 and the timer unit 220 are almost the same as the fault recovery processing unit 210 and the timer unit 220 shown in FIG. 2, differences therebetween will be focused on in the description below.

In S395 shown in FIG. 3, the timer unit 220 detects that the executing unit 200 is not operating normally for the fourth period during the third fault recovery processing and notifies the fault recovery processing unit 210 of such an event.

Upon notification of an anomaly of the executing unit 200 during the third fault recovery processing from the timer unit 220, the fault recovery processing unit 210 sets the PWRCTL signal, which is supplied to the power source unit 500 by the power source control unit 530, to a logical value 1 and thereby instructs the power source unit 500 to stop the supply of the main power and initiates the fourth fault recovery processing.

The power obtaining unit 520 obtains Vcc, which is the main power used for operating the storage device 110, from the I/O bus 280 inside the storage device 110.

Upon notification to stop the supply of the main power from the fault recovery processing unit 210, the power source control unit 530 sets the PWRCTL signal to a logical value 1. In following this, the power source unit 500 stops the supply of the main power on an instruction that is passed through the I/O bus 280 from the power source control unit 530.

Moreover, the power source control unit 530 sets the PME# signal of the I/O bus 280 to a logical value 1 and instructs the power source unit 500 to initiate the supply of the main power through the I/O bus 280, with a prerequisite that the supply of the main power from the power source unit 500 to the storage device 110 is stopped. Thus, the power source control unit 530 can turn on the power of the storage device 110 to start up the storage device 110 when the power of the storage device 110 is off.

The following will describe in more detail the operation of the storage device 110 of the modified example when a timeout occurs in S395 shown in FIG. 3. If the timeout occurs in S395, the power source control device 510 performs the fourth fault recovery processing. More specifically, through the power source control unit 530, the fault recovery processing unit 210 stops the supply of the main power provided by the power source unit 500. When the supply of the main power stops, the power source control unit 530 allows the power source unit 500 to resume the supply of the main power. When the supply of the main power from the power source unit 500 is resumed, the storage device 110 proceeds with the processing sequentially from S300 in FIG. 3.

Thus, after turning off the power of the storage device 110 once as the fourth failure recovery processing, the power source unit 500 can turn on the power again. In following this, the power source control device 510 according to the modified example, gains the possibility that it may enable the restoration of the operation of the storage device 110 even in case of failure from which the storage device 110 cannot recover by resetting the entire storage device 110.

Moreover, even in the event that the supply of the main power from the power source unit 500 is stopped due to a power failure, the power source control device 510 starts up the storage device 110 when the power failure is over. To be more precise, the storage device 110 performs the following operation in this case.

When power failure occurs, the power source unit 500 firstly stops the supply of the main power Vcc and the auxiliary power VccAUX. When the power failure is over, the power source unit 500 initiates the supply of the auxiliary power in a state where the supply of the main power is stopped.

When the supply of the auxiliary power is initiated, the power source control device 510 resumes power source control operation. Then, the power source control unit 530 detects that the supply of the main power stops, and instructs the power source unit 500 to initiate the supply of the main power using the PME# signal. Upon notification from the power source control unit 530, the power source unit 500 resumes the supply of the main power.

As described above, the power source control device 510, according to the modified example, makes it possible to initiate the supply of the main power and to start up the storage device 110 automatically after recovery from power failure.

Alternatively, the fault recovery processing unit 210 may use a combination of instructions when setting the first to fourth fault recovery processings. For example, a combination such as resetting the entire storage device 110 in the first fault recovery processing, and turning on/off the power storage device 100 upon the second fault recovery processing, or other combinations could be used.

Moreover, the power source control unit 530 may instruct the power source unit 500 to initiate the supply of the main power through the I/O bus 280 with a prerequisite that a predetermined time (for example, 10 seconds or the like) has passed after the supply of the main power stopped. Thus, the power source control unit 530 can turn on the power of the storage device 110 after electric discharges of the capacitor and the like inside the storage device 110. Alternatively, the power source control unit 530 may instruct the power source unit 500 to initiate the supply of the main power through the I/O bus 280 with a prerequisite that the fault recovery processing unit 210 has instructed the power source control unit 530 to stop the supply of the main power and thereby the power source control unit 530 then stopped the supply of the main power to result in stoppage of the supply of the main power. Thus, the power source control unit 530 can prevent the power of the storage device 110 from being turned on against the will of a user of the storage device 110 when the user turns off the power of the storage device 110.

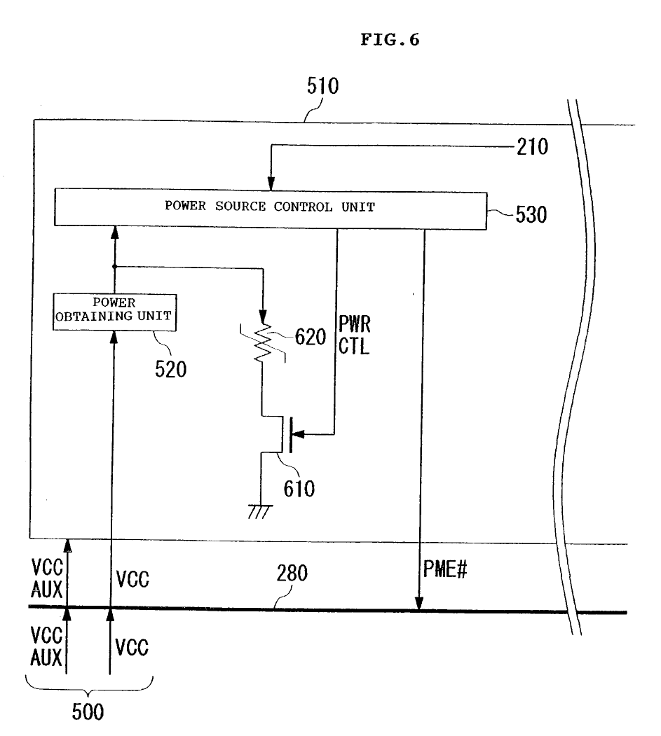

FIG. 6 shows a power source control part of a power source control device 510 according to a second modified example of the embodiment. The power source control device 510 according to the modified example has a switch 610 and a polyswitch 620 in addition to a fault recovery processing unit 210, a timer unit 220, a power obtaining unit 520 and a power source control unit 530. Since the fault recovery processing unit 210, the timer unit 220, the power obtaining unit 520 and the power source control unit 530 in the modified example are same as the corresponding members in FIG. 5, a description thereof will be omitted.

The switch 610 is located between the main power inputted through the polyswitch 620 and the ground. If a PWRCTL signal of the power source control unit 530 has a logical value 1, the switch 610 short-circuits the main power Vcc of the storage device 110 to the ground.

The polyswitch 620 is located between the main power inputted from the power obtaining unit 520 and the switch 610. When the switch 610 short-circuits the main power to the ground, if an over current flows between the main power and the ground, the polyswitch 620 cuts the flow of the electric current between the main power and the ground.

The power source control device 510 according to the modified example stops the supply of the main power from a power source unit 500 by operation described below.

First, the power source control unit 530 receives an instruction to stop the supply of the main power from the fault recovery processing unit 210. Next, the power source control unit 530 sets the PWRCTL signal to a logical value 1. Next, the switch 610 short-circuits the main power to the ground into a state allowing an electric current to flow because of the PWRCTL signal changing to the logical value 1.

When the main power is short-circuited to the ground, an over current flows between the main power and the ground. When the over current flows between the main power and the ground, the polyswitch 620 cuts the flow of the electric current between the main power and the ground. Thus, the polyswitch 620 brings the short-circuited state between the main power and the ground to an end in a short period of time. On the other hand, the power source unit 500 detects the short-circuited state and allows an over current protection (OCP) function to work, thereby stopping the supply of the main power.

As described above, the power source control device 510 according to the modified example stops the supply of the main power by using the OCP function of the power source unit 500. Therefore, it is possible to stop the supply of the main power without providing a signal equivalent to the PWRCTL signal of FIG. 5 in the power source unit 500.

As described above, according to the storage device 110 of the embodiment, the fault recovery processing unit 210 can detect that the executing unit 200 is not operating normally for the set period by use of the timer unit 200, whereby the fault recovery processing unit 210 can allow the executing unit 200 to initiate the fault recovery processing. Moreover, in the event that the storage device 110 is executing any of the normal processing, the first fault recovery processing and the second fault recovery processing, the fault recovery processing unit 210 can initiate different fault recovery processing depending on whether an anomaly is detected at the processor 240. To be more precise, the first fault recovery processing uses interrupt into the processor 240 to initiate the fault recovery processing, the second fault recovery processing uses reset of the processor 240 to initiate the fault recovery processing and the third fault recovery processing uses reset of the entire storage device 110 to initiate the recovery processing, respectively. Therefore, as the recovery processing proceeds stepwise from the first fault recovery processing, to the second fault recovery processing and further to the third fault recovery processing, it is possible to restore the storage device 110 from more serious failure. Moreover, the power source control device 510 according to the modified example of the embodiment provides the fourth fault recovery processing in which the power of the storage device 110 is once turned off and then turned on again. Therefore, by using the power source control device 510, the storage device 110 will have a good chance of being able to restore the operation thereof, even in case of failure from which the storage device 110 cannot recover by resetting the entire storage device 110.

Moreover, according to the storage device 110 of the embodiment, upon detecting that the processor 240 is not operating normally for the set period, the fault recovery processing unit 210 performs the fault recovery processing starting stepwise from the first fault recovery processing with a small range of initialization of the internal state. In this way, the failure information obtaining unit 230 can obtain as much failure information as possible, which is used for an analysis, identification and/or restoration of the failure. Meanwhile, when the failure is severe, the fault recovery processing unit 210 resets the entire storage device 110 ultimately at initiation of the third fault recovery processing. Therefore, according to the storage device 110 of the embodiment, it is possible to enhance possibility to restore operation of the storage device 110 in case of failure.

Furthermore, according to the storage device 110 of the embodiment, the fault recovery processing unit 210 stops action of the driving unit 255 at initiation of the first fault recovery processing. In this way, the storage device 110 can prevent the recording medium 257 itself or the data stored in the recording medium 257 from mechanical or electrical destruction in the event of failure.

Although the present invention has been described with reference to one or more certain embodiments, it is to be understood that the technical scope of the present invention is not limited to the specific embodiment described above. It is evident from the appended claims that various modifications and improvements are applicable to the above-described embodiment, and those modified or improved modes can be also included within the technical scope of the present invention.

For example, the driving unit 255 is not limited to the device including the motor 258 and/or the head 259 and the like, which perform mechanical action. Moreover, the storage device 110 may be also a computer such as a personal computer, a workstation or a server, which includes an input device, a display device, and the like. In this case, the storage device 110 can detect that operation of application software and/or an operating system and the like to be executed on the storage device 110 is hung up, by means of detecting a timeout. Therefore, the storage device 110 can allow the failure information obtaining unit 230 to obtain as much failure information as possible used for an analysis, identification and/or restoration of the failure. Moreover, the power source control device 510 according to the modified example of the embodiment can restart the storage device 110 even when failure occurs in application software and/or an operating system which is executed on the storage device 110, and the operating system shuts down the storage device 110 to turn off the power thereof.

Moreover, instead of the processor 240, the executing unit 200 according to the embodiment may be also realized with a control circuit which processes the normal processing, the first fault recovery processing, the second fault recovery processing and the third fault recovery processing only with hardware.

It will be further understood that various changes in the details, materials, and arrangements of the parts which have been described and illustrated in order to explain the nature of this invention may be made by those skilled in the art without departing from the principle and scope of the invention as expressed in the following claims.

What is claimed is:

1. An information processing device comprising:
an executing unit for executing any one of normal processing, first fault recovery processing and second fault recovery processing;
a fault recovery processing unit for allowing the executing unit to initiate the first fault recovery processing with a prerequisite that the executing unit is operating unsuccessfully in a first period during the normal processing and for allowing the executing unit to initiate the second fault recovery processing with a prerequisite that the executing unit is operating unsuccessfully in a second period during the first fault recovery processing; and
a failure information obtaining unit for obtaining an internal state of the executing unit after initiating the first fault recovery processing, the internal state being unobtainable after initiating the second fault recovery, as failure information.

2. The device according to claim 1,
wherein the executing unit comprises:
a first recording portion for holding the internal state to be initialized when the fault recovery processing unit initiates the second fault recovery processing; and
a failure information recording portion to be excluded from initialization when the fault recovery processing unit initiates the second fault recovery processing,
whereby
the executing unit obtains the internal state held by the first recording portion and stores the internal state in the failure information recording portion upon the first fault recovery processing, and
the failure information obtaining unit obtains the internal state stored in the failure information recording portion as the failure information upon the first fault recovery processing.

3. The device according to claim 2,
wherein the executing unit includes a second recording portion to be excluded from initialization when the fault recovery processing unit initiates the second fault recovery processing, and
the failure information obtaining unit further obtains information stored by the second recording portion as the failure information, in addition to the internal state stored in the failure information recording portion.

4. The device according to claim 1,
wherein the executing unit includes:
a functional unit to be initialized when the fault recovery processing unit initiates the second fault recovery processing; and
a failure information recording portion to be excluded from initialization when the fault recovery processing unit initiates the second fault recovery processing,
the executing unit stores information held by the functional unit into the failure
information recording portion as the internal state upon the first fault recovery processing, and
the failure information obtaining unit outputs the internal state stored in the failure information recording portion as the failure information upon the first fault recovery processing.

5. The device according to claim 1, further comprising:
a timer unit for detecting that the executing unit is operating unsuccessfully for a set period when the timer unit fails to receive normal-operation information from the executing unit, which indicates that the executing unit is operating normally, for the set period,
wherein the fault recovery processing unit detects that the executing unit is operating unsuccessfully for a first period during the normal processing and that the executing unit is operating unsuccessfully for a second period during the first fault recovery processing by use of the timer unit.

6. The device according to claim 5, wherein the executing unit transmits information, which indicates to allow the timer unit to initiate measurement for the set period, to the timer unit as the normal-operation information.

7. The device according to claim 1,
wherein the executing unit includes a processor for executing a command to control the device, and
the fault recovery processing unit initiates the first fault recovery processing by interrupting into the processor.

8. The device according to claim 7, wherein the fault recovery processing unit initiates the second fault recovery processing by resetting the processor.

9. The device according to claim 7, wherein the fault recovery processing unit initiates the second fault recovery processing by resetting the device.

10. The device according to claim 1,
wherein the executing unit includes a processor for executing a command to control the device, and
the fault recovery processing unit initiates the first fault recovery processing by resetting the processor and initiates the second fault recovery processing by resetting the device.

11. The device according to claim 1,
wherein the fault recovery processing unit further allows the executing unit to initiate third fault recovery processing with a prerequisite that the executing unit is operating unsuccessfully in a third period during the second fault recovery processing; and
a failure information obtaining unit obtains an internal state of the executing unit after initiating the second fault recovery processing, the internal state being unobtainable after initiating the third fault recovery, as the failure information in the third fault recovery processing.

12. The device according to claim 1, further comprising:
a driving unit for performing mechanical action,
wherein the fault recovery processing unit stops action of the driving unit upon instructing the executing unit to initiate the first fault recovery processing.

13. The device according to claim 1,
wherein the device is a storage device including a recording medium for storing data received from outside, and further a motor and a head to be used for having access to the recording medium,
the fault recovery processing unit stops action of the motor and access to the recording medium by the head upon instructing the executing unit to initiate the first fault recovery processing.

14. The device according to claim 1, wherein the fault recovery processing unit uses one identical period as the first period and as the second period.

15. The device according to claim 1, further comprising:
a power source control device which is connected to an input/output bus of a main body of the information processing device and to which main power used for operating the information processing device is inputted from the device,
wherein the fault recovery processing unit instructs stoppage of a supply of the main power through the input/output bus and thereby initiates the second fault recovery processing, and
the power source control device instructs initiation of the supply of the main power through the input/output bus to start up the information processing device during the second fault recovery processing with a prerequisite that the supply of the main power to the device has been stopped.

16. A power source control device which is connected to an input/output bus of an information processing device, comprising:
a power obtaining unit which obtains main power used for operating the information processing device from the information processing device; and
a power source control unit for instructing initiation of supply of the main power through the input/output bus to start up the information processing device with a prerequisite that the supply of the main power has been stopped.

17. The device according to claim 16,
wherein the input/output bus is a PCI bus, and
the power source control unit instructs initiation of the supply of the main power using a Power Management Event (PME#) signal of the PCI bus.

18. The device according to claim 16, wherein the power source control unit instructs initiation of the supply of the main power through the input/output bus with a prerequisite that a predetermined time has passed after the supply of the main power has stopped.

19. The device according to claim 16, further comprising:
a fault recovery processing unit for instructing stoppage of the supply of the main power through the input/output bus when the fault recovery processing unit decides that the information processing device is operating unsuccessfully.

20. The device according to claim 16, wherein, when the information processing device is operating unsuccessfully, the power source control unit allows an over current protection function of a power source unit, which is provided inside the information processing device and supplies the main power, to work by short-circuiting the main power, and stops the supply of the main power provided by the power source unit.

21. The device according to claim 16, wherein the power source control unit instructs initiation of the supply of the main power through the input/output bus with a prerequisite that a fault recovery processing unit has instructed stoppage of the supply of the main power and that the supply of the main power has been stopped.

22. The device according to claim 16, wherein the power source control unit instructs initiation of the supply of the main power through the input/output bus to start up the information processing device when the supply of the main power is stopped by power failure and then the power failure is over.

23. A method of controlling an information processing device for allowing the information processing device to perform processing, the method comprising the steps of:
allowing the information processing device to execute any one of normal processing, first fault recovery processing and second fault recovery processing;
allowing the information processing device to initiate the first fault recovery processing with a prerequisite that the normal processing is operating unsuccessfully in a first period;
allowing the information processing device to initiate the second fault recovery processing with a prerequisite that the first fault recovery processing is operating unsuccessfully in a second period; and
allowing the information processing device to obtain an internal state of the executing unit after initiating the first fault recovery processing, the internal state being unobtainable after initiating the second fault recovery, as failure information.

24. A program for causing an information processing device to execute processing, the program causing the information processing device to execute procedures for:
operating as an executing unit for executing any one of normal processing, first fault recovery processing and second fault recovery processing;
operating as a fault recovery processing unit for allowing the executing unit to initiate the first fault recovery processing with a prerequisite that the executing unit is operating unsuccessfully in a first period during the normal processing and for allowing the executing unit to initiate the second fault recovery processing with a prerequisite that the executing unit is operating unsuccessfully in a second period during the first fault recovery processing; and
operating as a failure information obtaining unit for obtaining an internal state of the executing unit after initiating the first fault recovery processing, the internal state being unobtainable after initiating the second fault recovery, as failure information.

25. The program according to claim 24, further causing the information processing device to execute a procedure for:
operating as a timer unit for detecting that the executing unit is operating unsuccessfully for a set period when the timer unit fails to receive normal-operation information from the executing unit, which indicates that the executing unit is operating normally, for the set period,
wherein the fault recovery processing unit detects that the executing unit is operating unsuccessfully for a first period during the normal processing and that the executing unit is operating unsuccessfully for a second period during the first fault recovery processing by use of the timer unit.

26. A recording medium having a program recorded thereon, the program causing an information processing device to execute procedures for:
operating as an executing unit for executing any one of normal processing, first fault recovery processing and second fault recovery processing;
operating as a fault recovery processing unit for allowing the executing unit to initiate the first fault recovery processing with a prerequisite that the executing unit is operating unsuccessfully in a first period during the normal processing and for allowing the executing unit to initiate the second fault recovery processing with a prerequisite that the executing unit is operating unsuccessfully in a second period during the first fault recovery processing; and
operating as a failure information obtaining unit for obtaining an internal state of the executing unit after initiating the first fault recovery processing, the internal state being unobtainable after initiating the second fault recovery, as failure information.

27. The recording medium according to claim 26,
wherein the program further causes the information processing device to execute a procedure for operating as a timer unit for detecting that the executing unit is operating unsuccessfully for a set period when the timer unit fails to receive normal-operation information from the executing unit, which indicates that the executing unit is operating normally, for the set period, and
the fault recovery processing unit detects that the executing unit is operating unsuccessfully for a first period during the normal processing and that the executing unit is operating unsuccessfully for a second period during the first fault recovery processing by use of the timer unit.
